(19) United States
(12) Patent Application Publication
(10) Pub. No.: US 2014/0231723 A1
(43) Pub. Date: Aug. 21, 2014

(54) ENHANCING SILVER CONDUCTIVITY

(71) Applicants: Kurt Michael Sanger, Rochester, NY (US); Charles Francis Scaglione, Bergen, NY (US)

(72) Inventors: Kurt Michael Sanger, Rochester, NY (US); Charles Francis Scaglione, Bergen, NY (US)

(21) Appl. No.: 13/771,549

(22) Filed: Feb. 20, 2013

(51) Int. Cl. H01B 1/02

(52) U.S. Cl. CPC H01B 1/02
USPC 252/514

(57) ABSTRACT

A method of enhancing the conductivity of silver in a silver-containing film formed on a substrate is disclosed. A silver-containing film, including silver particles and a hydrophilic binder is produced. Thereafter, the method includes exposing the silver-containing film to hot water vapor so that the binder absorbs water; drying the silver-containing film to remove water in the binder, and repeating the hot water vapor and drying steps at least one additional time to enhance the conductivity of the silver.

### FIELD OF THE INVENTION

The present invention relates to enhancing the conductivity of silver-containing film having silver particles in a hydrophilic binder.

### BACKGROUND OF THE INVENTION

Touch screen displays use Indium Tin Oxide (ITO) coatings to create arrays of capacitive areas used to distinguish multiple point contacts. ITO coatings have significant short comings. Indium is an expensive rare earth metal and is available in limited supply. ITO conductivity is relatively low requiring short line lengths to achieve adequate response rates. Touch screens for large displays are broken up into smaller segments to reduce the conductive line length to an acceptable resistance. These smaller segments require additional driving and sensing electronics. In addition ITO is a ceramic material, does not like to be bent or flexed, and it requires vacuum deposition with high processing temperatures.

Silver is an ideal conductor having conductivity 50 to 100 times that of ITO. Unlike most metal oxides, silver oxide is still reasonably conductive and this reduces the problem of making reliable electrical connections. Silver is used in many commercial applications and is available from numerous sources.

Ichiki, US. Patent Application Publication 2011/0308846, discloses a conductive film formed by processing a silver halide image into conductive networks with silver wire sizes less than 10 μm and a resistance of 50 Ω/□ or less. Ichiki further discloses conductive lines with resistances of 100Ω or less per 10 mm in length. The conductive network has a lattice pattern such that light transmittance through the film is 80% or more. Ichiki discloses using this conductive film to form a touch panel in a display.

Tokunaga, U.S. Pat. No. 7,985,527, discloses producing a conductive film wherein the conductive material is in the binder having the steps of contacting the conductive metal portion with vapor or hot water. The hot water is 40° C. or higher. Tokunaga discloses a binder that is a water soluble polymer, a conductive film containing a film curing agent, use of a smoothing treatment which includes pressure, post washing the conductive film in water after treating with a vapor, and using a vapor that is 80° C. or hotter. Tokunaga teaches to immerse the conductive film in hot water with temperatures of 40° C., 60° C., 80° C. or hotter. In addition Tokunaga discloses producing a conductive film with a conductive material in a water soluble binder using a hygrothermal treatment consisting of a humidity adjusted condition with a temperature of 40° C. or higher and a relative humidity of 5% or more. Gelatin is disclosed as a water soluble polymer.

Blake, U.S. Pat. No. 3,464,822, discloses forming a developable silver halide image in a photographic element with a water permeable emulsion layer and using a developer to develop a conductive silver surface image with a resistance of 5 ohms/□ or less. Blake discloses processing exposed films with single or dual bath methods which include a water rinse after each bath.

King and Haist, U.S. Pat. No. 3,033,765, disclose photographic production of electrically conducting silver images. Nonexposed regions become conductive such that the process is negative acting. Conductive traces were transferred to secondary receivers or developed directly on the coated support. Copper plating was shown in one example to increase conductivity. King and Haist disclose an example that used a pressure roller to transfer the image from the first support to a second receiver.

Using a photographic emulsion to create a conductive trace is problematic as the elements of the emulsion, particularly gelatin, surround the developed silver nanoparticles making them less conductive. To conduct electricity, silver nanoparticles need to be connected to some degree to permit electrons to percolate through the matrix. Gelatin and other emulsion materials can act as a barrier to electron mobility. Hardeners are routinely added to the emulsion to provide some physical robustness to the film for further processing and handling. Without the hardener the emulsion is water soluble and difficult to process. However, the presence of hardener generally enhances the barrier properties of the gel, thereby reducing conductivity further.

Photographic emulsions using gelatin as a binder tend to increase in hardness over time. Gelatin used in conductive photographic emulsions is a good absorber of water and its moisture content changes quickly with atmospheric relative humidity.

### SUMMARY OF THE INVENTION

It has been discovered that, by making use of a hydrophilic binder, the conductivity of the silver can be significantly improved.

In accordance with the present invention, there is provided a method of enhancing the conductivity of silver in a silver-containing film formed on a substrate, comprising:

(a) providing the silver-containing film, including silver particles and a hydrophilic binder;

(b) exposing the silver-containing film to hot water vapor so that the binder absorbs water;

(c) drying the silver-containing film to remove water in the binder; and

(d) repeating elements (b) and (c) at least one time, so as to enhance the conductivity of the silver.

In another aspect of the present invention, there is provided a method of enhancing the conductivity of silver in a silver-containing film formed on a substrate, comprising:

(a) providing the silver-containing film, including silver particles and a hydrophilic binder;

(b) swelling the hydrophilic binder;

(c) shrinking the hydrophilic binder; and

(d) repeating elements (b) and (c) at least one time to work the silver particles thereby enhancing the conductivity of the silver.

Advantages of the present invention include the fact that silver is worked by making use of the hydrophilic nature of the binder along with repeated swelling and shrinking steps. In one embodiment, the silver-containing film is exposed to hot water vapor and then dried, and the process is repeated. In another embodiment, the silver-containing film is exposed to a water bath then dried, and the process is repeated.

An advantage of the present invention is that the use of multiple, short treatment steps is significantly more efficient at improving conductivity than a single long treatment.

### BRIEF DESCRIPTION OF THE DRAWINGS

FIG. 1 is a schematic of a system including two sets of processing stations, with each set having a hot water vapor station and a drying station;

FIG. 2 is a cross sectional view of a silver-containing conductive film in an embodiment of the present invention having an exposed and processed photographic emulsion layer;

FIG. 3 is a cross sectional view of a typical silver-containing conductive film in an embodiment of the present invention having printed areas of conductive material;

FIG. 4 is a chart showing the change in resistance as a function of hot water vapor and dry treatment cycles in an embodiment of the present invention;

FIG. 5 is a chart showing the change in resistance as a function of water bath and dry treatment cycles in an embodiment of the present invention; and

FIG. 6 is a schematic of a system including two sets of processing stations, with each set having a water bath station and a drying station.

### DETAILED DESCRIPTION OF THE INVENTION

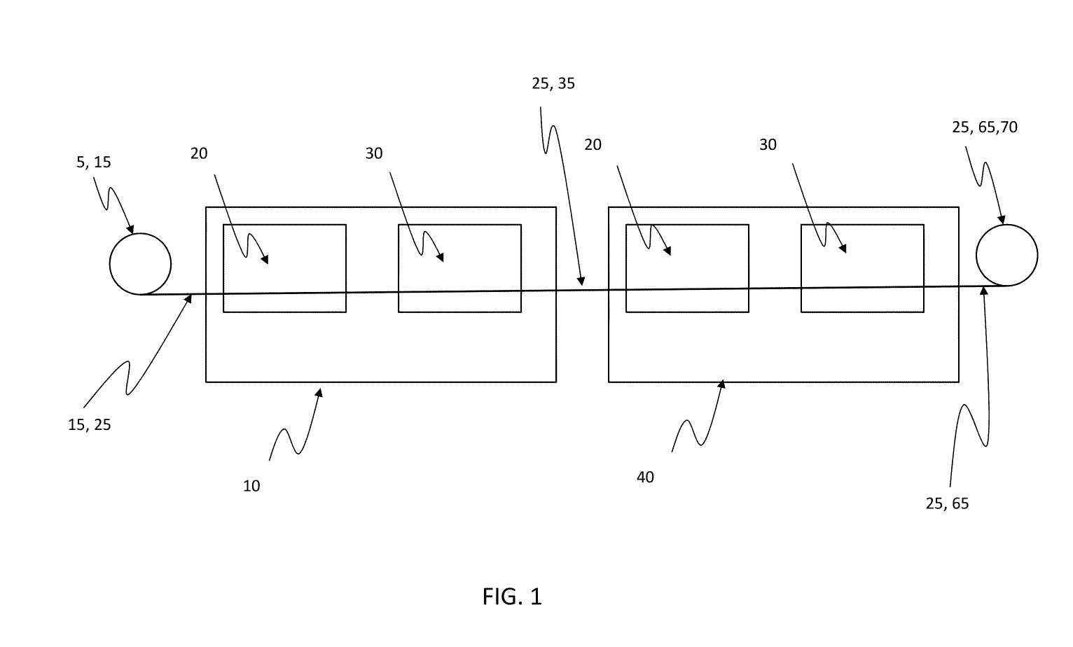

FIG. 1 is an embodiment of the present invention and includes a first set of stations 10, and a second set of stations 40. Each set of stations contains a hot water vapor station 20 followed by a drying station 30. A roll of exposed and processed silver-containing conductive film 15 is loaded into a supply spool 5. A web 25 of exposed and processed silver-containing conductive film 15 is input to the first set of stations 10 where it passes through the hot water vapor station 20, followed by the drying station 30 and exits as the web 25 of treated conductive film 35. The web 25 of treated conductive film 35 then enters the second set of stations 40 where it passes through the hot water vapor station 20, followed by the drying station 30 and exits as the web 25 of additionally treated conductive film 65. Web 25 of additionally treated conductive film 65 is then wound onto a take-up spool 70 and is then ready for use. If conductive film 15 has conductive traces on both sides, the hot water vapor station 20 and the drying station 30 can be configured to treat both sides.

The first set of stations 10 and second set of stations 40 can be one physical unit and the web 25 of material can be passed through the first set of stations 10 multiple times.

Additional sets of stations can be placed in line and the web can be processed more than two times. The duration and temperature of the hot water vapor treatment section, the duration and temperature of the drying station, and the speed of the web can be adjusted to optimize the treatments. The adjustments can be dependent upon the treatment cycle number and the conductive film type.

The present invention can be applied using cut sheets of silver-containing conductive film and moving the film through the first and second set of stations on a belt or a conveyor. The present invention can be applied using cut sheets of silver-containing conductive film and moving the film through a single first set of stations multiple times.

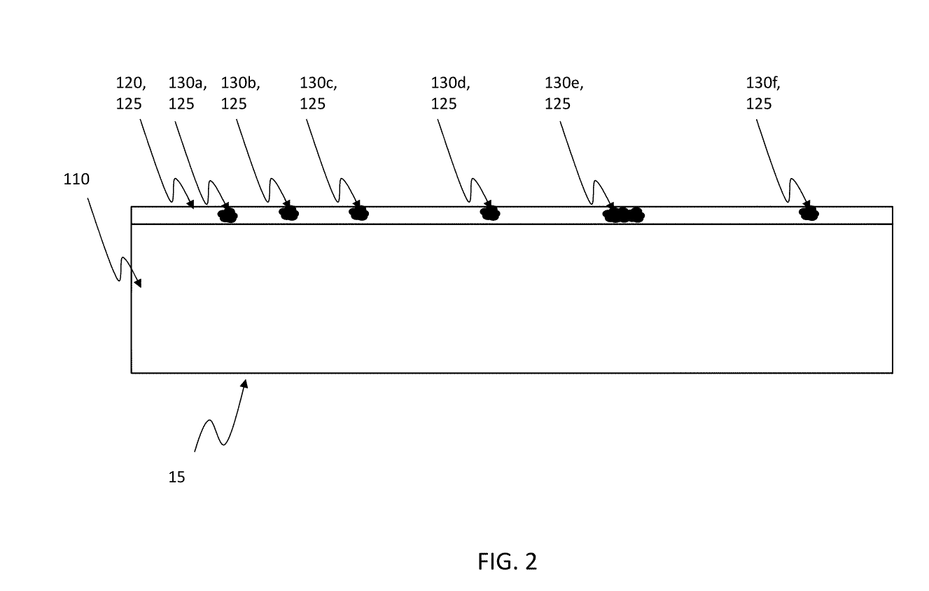

FIG. 2 is a cross section of an exposed and processed silver-containing conductive film 15. In this embodiment, the exposed and processed silver-containing conductive film 15 includes a support 110 with a processed photographic emulsion layer 120 having a hydrophilic binder 125 and conductive traces 130a-f. Conductive traces 130a-f are made up of small metallic silver nanoparticles mixed with hydrophilic binder 125.

The support 110 can be glass, paper, plastic, PET, metallic or another suitable material. The support 110 can have other layers. The support 110 can have other functionality. The support 110 can optionally be folded, cut, embossed, or otherwise distorted as needed.

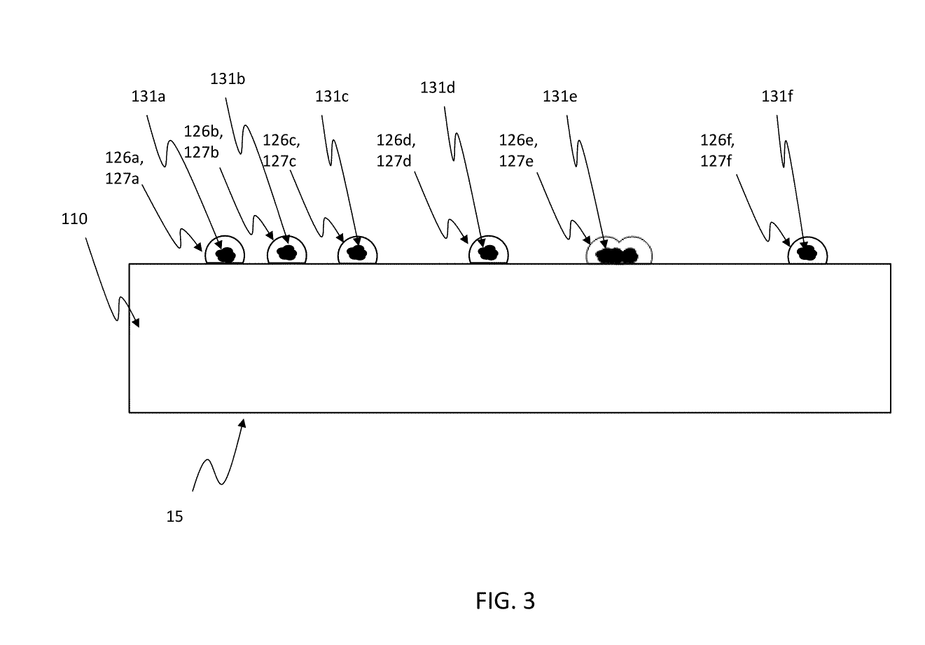

FIG. 3 is a cross section of exposed and processed silver-containing conductive film 15 according to another embodiment. In this embodiment, silver-containing conductive film 15 includes the support 110 with printed areas 127a-f of a conductive material having both a hydrophilic binder 126a-f and a conductive metal nanoparticles 131a-f nanoparticles mixed with hydrophilic binder 126a-f.

Printed areas 127a-f can be printed using inkjet, flexography, screen printing, thermal or laser transfer, offset lithographic printing, pad printing, stamp printing, gravure printing or any other suitable printing method.

In an embodiment, the printed areas 127a-f can be a silver ink having silver nanoparticles provided in the hydrophilic binder 126a-f. In another embodiment, silver metal precursor materials can be printed and then processed to form the silver nanoparticles. For example, one can print a photographic emulsion that can then be exposed using any masked or unmasked light source, and processed to form silver nanoparticles in a gelatin binder.

The temperature of the hot water vapor should be at least 50° C. Although the temperature upper limit depends on the system, for photographic based systems, the temperature of the hot water vapor is generally less than about 150° C. A useful range of hot water vapor temperature is from 80° C. up to and including 110° C. or it can be in a range from 90° C. up to and including 100° C. The multiple hot water vapor treatments do not necessarily need to be conducted at the same temperature.

The exposure time for the silver-containing film to the hot water vapor depends on the conditions and system, but it should generally be at least 1 sec. Generally, a useful hot water vapor exposure time range can be in range from 1 sec up to and including 60 sec, or more typically in a range from 5 sec up to and including 30 sec. The hot water vapor exposure time range can be from 5 sec up to and including 15 sec. The multiple hot water vapor treatments do not necessarily need to be conducted at the same time.

Although lower concentrations can be used, the gas phase concentration of water in the hot water vapor can be at or near its saturation point. The concentration of water in the hot water vapor can be 50 g/m³ or greater.

The drying step can be achieved by blowing relatively dry air or gas over the film or by heating or combinations thereof. In general, the drying temperature is in a range from 40° C. up to and including 140° C., or more typically in a range from 60° C. up to and including 100° C. Infrared radiation can optionally be used to heat the film.

### Conductive Films

Conductive traces can be formed by printing an ink containing a hydrophilic binder along with metal particles or metal salt precursors. Silver nanoparticles and silver salt precursors are particularly useful. In an embodiment, the silver traces can be formed by exposing and developing a coated layer of silver salt in a hydrophilic binder, as described below.

The substrate upon which a silver salt can be coated depends upon the intended utility and can be any substrate on which a conductive film or grid is desired. It can be rigid or flexible, opaque or transparent, depending upon the use. For example, the support substrate can be a transparent, flexible substrate. Such suitable substrates include, but are not limited to, glass, glass-reinforced epoxy laminates, cellulose triacetate, acrylic esters, polycarbonates, adhesive-coated polymer substrates, polymer substrates, and composite materials. Suitable polymers for use as polymer substrates include polyethylenes, especially polyethylene terephthalate (PET) and polyethylene naphthalate (PEN), polypropylenes, polyvinyl acetates, polyurethanes, polyesters, polyamides, polyimides, polysulfones, and mixtures thereof. The substrate, especially a polymer substrate, can be treated to improve adhesion of a silver salt emulsion or dispersion to one or both surfaces of the substrate. For example, the substrate can be coated with a polymer adhesive layer or one or both surfaces can be chemically treated or subjected to a corona treatment.

For coating onto a substrate in the manufacture of flexible electronic devices or components, the support can be flexible, which aids rapid roll-to-roll application. An Estar® PET film and a cellulose triacetate film are useful examples of flexible transparent substrates.

Alternatively, the substrate can be the same support used in a flexible display device, by which it is meant that a silver salt layer can be coated onto a support designed for a display device and imaged in situ according to a desired pattern, and then processed in situ.

Where a discrete substrate is utilized (that is, the substrate is not the reverse side of a support in a flexible display device), it can be coated with a silver salt layer on either side or both sides. If different patterns are intended for each side, the substrate or intervening layers of absorber dyes can be provided to prevent light exposure from one side reaching the other. Alternatively, the silver salts can be sensitized differently for each side of the substrate.

The silver salt can be any material that is capable of providing a latent image (that is, a germ or nucleus of metal in each exposed grain of metal salt) according to a desired pattern upon photo-exposure or thermal exposure. The latent image can then be developed into a metal image.

For example, the silver salt can be a photosensitive silver salt such as a silver halide or mixture of silver halides. The silver halide can be, for example, silver chloride, silver bromide, silver chlorobromide, or silver bromoiodide. In one useful embodiment, the silver halide dispersion (or emulsion as it can be called) is dispersed in a hydrophilic binder as a high contrast silver halide emulsion, which is suitable, for example, in the graphic arts and in manufacturing printed circuit boards (PCBs). One such high contrast silver halide emulsion is a silver chlorobromide emulsion, for example including at least 50 mol % silver chloride, typically at least 60 mol % and up to and including 90 mol % silver chloride, or more likely at least 60 mol % and up to and including 80 mol % silver chloride. The remainder of the silver halide can be substantially silver bromide.

Generally, the silver salt layer includes one or more hydrophilic binders or colloids. Non-limiting examples of such hydrophilic binders or colloids (for either a silver salt-based layer or a silver metal ink) include but are not limited to hydrophilic colloids such as gelatin or gelatin derivatives, polyvinyl alcohol (PVA), polyvinylpyrrolidone (PVP), casein, and mixtures thereof Suitable hydrophilic colloids and vinyl polymers and copolymers are also described in Section IX of Research Disclosure Item 36544, September 1994 that is published by Kenneth Mason Publications, Emsworth, Hants, PO10 7DQ, UK, and that is incorporated herein by reference for the portions that are relevant to silver halide photochemistry. A particular hydrophilic colloid is gelatin.

In many embodiments, the hydrophilic binder in the silver salt layer (or any other layer) includes one or more hardeners designed to harden the particular hydrophilic binder such as gelatin. Particularly useful hardeners include but are not limited to, non-polymeric vinyl-sulfones such as bis(vinyl-sulfonyl) methane (BVSM), bis(vinyl-sulfonyl methyl) ether (BVSME), and 1,2-bis(vinyl-sulfonyl acetoamide)ethane (BVSAE). Mixtures of hardeners can be used if desired.

One useful photosensitive silver salt composition is a high metal (for example, silver)/low binder (for example, gelatin) composition, that after silver salt development, is sufficiently conductive. Where the photosensitive silver salt layer includes an emulsion of silver halide dispersed in gelatin, a particularly useful weight ratio of silver to gelatin is 1.5:1 or higher in the silver salt layer. In certain embodiments, a ratio between 2:1 and 3:1 in the silver salt layer is particularly useful.

According to many embodiments, the useful silver salt is a silver halide that is sensitized to any suitable wavelength of exposing radiation. Organic sensitizing dyes can be used, but it can be advantageous to sensitize the silver salt in the UV portion of the electromagnetic spectrum without using sensitizing dyes. This avoids unwanted dye stains if the conductive film element is intended to be transparent.

Non-limiting examples of silver halide emulsions including addenda and hydrophilic binders that can be used in the present invention are described in Research Disclosure Item 36544, September 1994. Other useful silver salt emulsions are also described, for example in U.S. Pat. No. 7,351,523 (Grzeskowiak); U.S. Pat. Nos. 5,589,318 and 5,512,415 (both to Dale et al.), all of which are incorporated herein by reference.

Useful silver halide emulsions can be prepared by any suitable method of grain growth, for example, by using a balanced double run of silver nitrate and salt solutions using a feedback system designed to maintain the silver ion concentration in the growth reactor. Dopants can be introduced uniformly from start to finish of precipitation or can be structured into regions or bands within the silver halide grains. Dopants, for example osmium dopants, ruthenium dopants, iron dopants, rhenium dopants, iridium dopants, or cyanoruthenate dopants, can be added. A combination of osmium and iridium dopants such as osmium nitrosyl pentachloride, is useful. Such complexes can be alternatively utilized as grain surface modifiers in the manner described in U.S. Pat. No. 5,385,817 (Bell). Chemical sensitization can be carried out by any of the known silver halide chemical sensitization methods, for example using thiosulfate or another labile sulfur compound, or in combination with gold complexes.

The silver halide grains can be cubic, octahedral, rounded octahedral, polymorphic, tabular, or thin tabular emulsion grains. Such silver halide grains can be regular untwinned, regular twinned, or irregular twinned with cubic or octahedral faces. In one embodiment, the silver halide grains are cubic having an edge length of less than 0.5 μm, or less than 0.25 ηm, or at least 0.05 μm.

Specific references relating to the preparation of emulsions of differing halide ratios and morphologies are U.S. Pat. No. 3,622,318 (Evans); U.S. Pat. No. 4,269,927 (Atwell); U.S. Pat. No. 4,414,306 (Wey et al.); U.S. Pat. No. 4,400,463 (Maskasky); U.S. Pat. No. 4,713,323 (Maskasky); U.S. Pat. No. 4,804,621 (Tufano et al.); U.S. Pat. No. 4,783,398 (Takada et al.); U.S. Pat. No. 4,952,491 (Nishikawa et al.); U.S. Pat. No. 4,983,508 (Ishiguro et al.); U.S. Pat. No. 4,820,624 (Hasebe et al.); U.S. Pat. No. 5,264,337 (Maskasky); U.S. Pat. No. 5,275,930 (Maskasky); U.S. Pat. No. 5,320,938 (House et al.); U.S. Pat. No. 5,550,013 (Chen et al.); U.S. Pat. No. 5,726,005 (Chen et al.); and U.S. Pat. No. 5,736,310 (Chen et al.); all of which are incorporated herein by reference.

Antifoggants and stabilizers can be added to give the silver halide emulsion the desired sensitivity, if appropriate. Antifoggants that can be used include, for example, azaindenes such as tetraazaindenes, tetrazoles, benzotriazoles, imidazoles and benzimidazoles. Specific antifoggants that can be used include 5-carboxy-2-methylthio-4-hydroxy-6-methyl-1,3,3a,7-tetraazaindene, 1-(3-acetamidophenyl)-5-mercaptotetrazole, 6-nitrobenzimidazole, 2-methylbenzimidazole, and benzotriazole, individually or in combination.

Nucleators and development boosters can be used to give ultra-high contrast. For example, combinations of hydrazine nucleators such as those disclosed in U.S. Pat. No. 6,573,021 (Baker et al.), or hydrazine nucleators disclosed in U.S. Pat. No. 5,512,415 (Dale et al.) (col. 4, line 42 to col. 7, line 26) can be used, both references that are incorporated herein by reference. Booster compounds that can be present include amine boosters that include at least one secondary or tertiary amino group and have an n-octanol/water partition coefficient (log P) of at least 1, for example of at least 3. Suitable amine boosters include those described in U.S. Pat. No. 5,512,415 No. (col. 7, line 27 to col. 8, line 16). Useful boosters include bis-tertiary amines and bis-secondary amines, such as compounds having dipropylamino groups linked by a chain of hydroxypropyl units, such as those described in U.S. Pat. No. 6,573,021. Any nucleator or booster compound utilized can be incorporated into the silver halide emulsion, or alternatively can be present in a hydrophilic colloid layer that is adjacent the layer containing the silver halide emulsion for which the effects of the nucleator are intended.

In addition to the layer(s) containing the silver salt, the conductive film element can include other layers such as overcoat layers, light absorbing filter layers, adhesion layers, and other layers as are known in the art. For example, light absorbing filter layers can include one or more filter dyes that absorb in the UV, red, green, or blue regions of the electromagnetic spectrum, or any combination thereof.

In embodiments wherein a silver salt layer is provided on both sides of the substrate and is exposed with radiation of a particular wavelength, it is useful to provide a light absorbing filter layer including a filter dye between the silver salt layer and the substrate wherein the filter dye absorbs the chosen exposing radiation. Both sides can optionally include this light absorbing filter layer.

In certain useful embodiments, the silver coverage in the conductive film element precursor is at least 2000 mg/m² and the silver to gelatin weight ratio in the silver salt layer is at least 1.5:1.

Numerous developing solutions (identified herein also as “developer”) are known that can develop the exposed silver salts described above to form silver metal, for example in the form of a grid pattern. It has been found, that commercially available developers do not necessarily provide conductivity across the grid pattern that is desired. In many cases, the developers provide no measurable conductivity, even though there can be a visible image. One developer that yielded some conductivity is Accumax® silver halide developer when used to process exposed silver chlorobromide based films such as those used in graphic arts. However, it does not provide the conductivity needed for certain uses. The examples described below demonstrate useful developers that can convert a silver salt to silver metal and then provide improved conductivity.

Developers are generally aqueous solutions including one or more silver salt (such as a silver halide) developing agents, of the same or different type, including but not limited to, polyhydroxybenzenes (such as dihydroxybenzene, or in its form as hydroquinone), aminophenols, p-phenylenediamines, ascorbic acid and its derivatives, reductones, erythorbic acid and its derivatives, pyrazolidone, pyrazolone, pyrimidine, dithionite, and hydroxylamines. One or more developing agents can be present in an amount of at least 0.005 mol/l and up to and including 2 mol/l, or typically in an amount of at least 0.05 mol/l and up to and including 0.5 mol/l.

The developers can also include auxiliary silver developing agents that exhibit super-additive properties with a developing agent. Such auxiliary developing agents can include but are not limited to, Elon and substituted or unsubstituted phenidones, in an amount of at least 0.0001 mol/l and up to and including 0.02 mol/l, or typically in an amount of at least 0.001 mol/l and up to and including 0.005 mol/l.

Useful developers can also include one or more silver complexing agents (or silver ligands) including but not limited to, sulfite, thiocyanate, thiosulfate, thiourea, thiosemicarbazide, tertiary phosphines, thioethers, amines, thiols, aminocarboxylates, triazolium thiolates, pyridines (including bipyridine), imidazoles, and aminophosphonates. The useful amount of one or more silver complexing agents is at least 0.05 g/l and up to and including 2.0 g/l.

Other addenda that can be present in the developers in amounts that would be readily known, include but are not limited to, metal chelating agents, antioxidants, small amounts of water-miscible organic solvents (such as benzyl alcohol and diethylene glycol), nucleators, and acids, bases, and buffers (such as carbonate, borax and other basic salts) to establish a pH of at least 8 and generally of a pH of at least 9.5.

Multiple development steps can be used. For example, a first developer can provides initial development and then a second developer that having higher silver salt solubilizing power can be used to provide “solution physical development”.

Useful developer temperatures can range from at least 15° C. and up to and including 50° C., and more typically from at least 25° C. and up to and including 40° C. Useful development times are in a range from at least 10 seconds and up to and including 10 minutes, and typically from at least 20 seconds and up to and including 5 minutes.

After development, the undeveloped silver salt is removed by treating the developed film with a fixing solution. Fixing solutions are well known in the art and contain compounds that complex the silver salt in order to dissolve undeveloped silver out of the binder. Thiosulfate salts are commonly used in fixing solutions. The fixing solution can optionally contain a hardening agent such as alum or chrome-alum. The developed film can be processed in a fixing solution immediately after development, or there can be an intervening stop bath or water wash or both. As well known in the art, a stop bath typically contains a dilute acid such as acetic or sulfuric acid. The pH is typically less than 5 and the stops development. After fixing, the film can be washed in water which can optionally include surfactants or other materials to reduce water spot formation upon drying. Drying can be conducted simply by drying in air or by heating, for example, in a convection oven. To improve conductivity, heating at a temperature above 80 C but below the Tg of the support, can optionally be performed.

Hardening solutions, e.g., containing alum or chrome-alum, can optionally be provided after fixing to improve the physical robustness of the films.

### EXAMPLES

Conductive films were prepared by exposing and processing a silver halide emulsion provided in a gelatin matrix on a 125 μm thick PET support. The silver halide emulsion had a composition of 70 mol % AgCl and 30 mol % AgBr. The emulsion grains had cubic morphology and an edge length 0.12 μm. The total silver coverage was 2.0 g/m² and weight ratio of silver to gelatin in the emulsion had about 2.3. A UV-absorption layer was provided between the PET support and the emulsion layer. BVSM [1,1′-(methylene(sulfonyl))bis-ethane] was coated at 0.5 weight % of total gelatin to harden the film.

The 35 mm strips of film were exposed with a chrome mask having a diamond-shaped grid pattern having corner-to-corner dimensions of 300 μm (vertical)×500 μm (horizontal). This grid pattern extended across 1×1 inch patch with solid contact pad areas at the upper and lower sides of the grid. The contact pad areas were 1 inch horizontal by 0.25 inches vertical. On the side of each solid contact area opposite the main 1×1 inch grid, was an additional grid (1 inch horizontal, 0.5 inch vertical) and additional solid contact area in order to enable 4-point probe measurements using all four solid contact pad areas. Alternatively, 2-point probe measurements could be made simply on the 1×1 inch grid using the contact pads in direct contact with that grid. The grid lines on the conductive film samples were approximately 6 μm wide.

Prior to hot water vapor treatments, the conductive film samples generally had a surface resistivity of about 50 to 80 Ω/□. The effect of vapor was monitored by analyzing the percent reduction in resistance from each starting resistance.

### Comparative Example 1

A conductive film sample was treated with hot water vapor by holding it over an Erlenmeyer flask containing boiling water. The temperature of the hot water vapor exiting the flask measured 95° C. The sample was treated for 15 min then dried by holding the treated sample over a hot plate for about 5 sec. The resistance of the 1 inch square grid before treatment was 75.2 Ω/□. After the 15 min treatment, the resistance was 39.3 Ω□. Thus, the single 15 min hot water vapor treatment produced a 48% reduction in resistance.

### Example 1

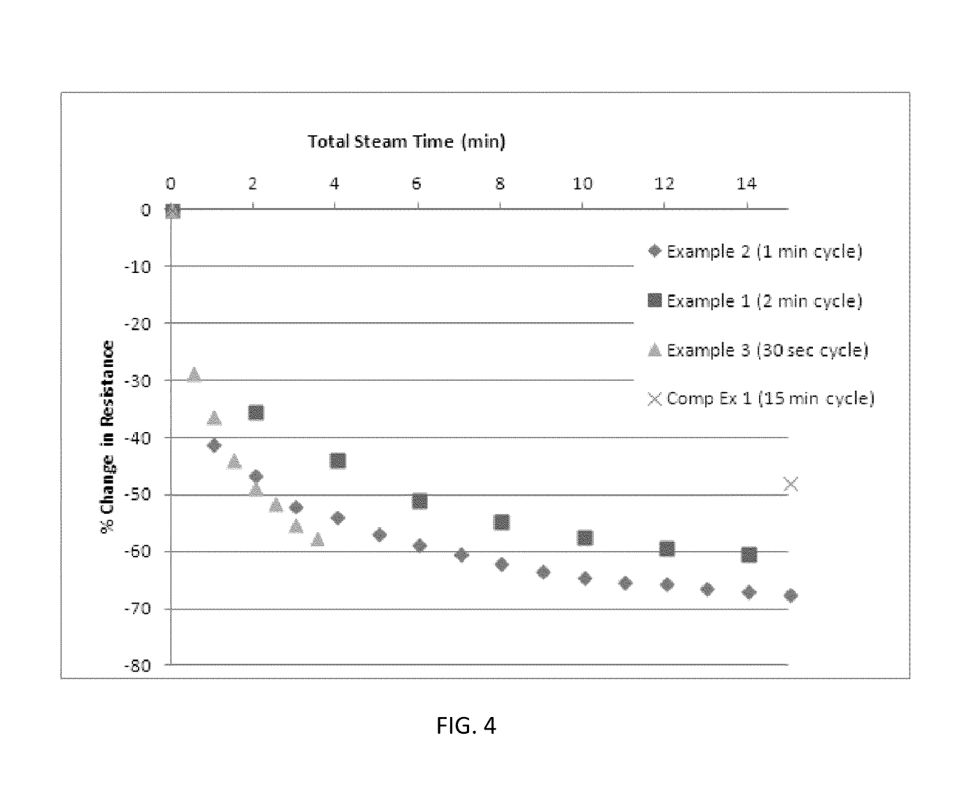

A conductive film sample having a starting resistance of 79.2 Ω/□ was treated with hot water vapor as in Comparative Example 1, except that multiple treatments of 2 min each were used. Between each 2 min treatment, the film was dried by holding it over a hot plate for about 5 sec and the resistance was measured. The resulting change in resistance as a function of total hot water vapor treatment time is shown in FIG. 4.

### Example 2

A conductive film sample was treated as in Example 1 except that each treatment time was 1 min. The resulting change in resistance as a function of total hot water vapor treatment time is shown in FIG. 4.

### Example 3

A conductive film sample was treated as in Example 1 except that each treatment time was 30 sec. The resulting change in resistance as a function of total hot water vapor treatment time is shown in FIG. 4.

A single hot water vapor treatment of 15 min does provide a reasonable reduction in resistance. As can be seen in FIG. 4, however, it was unexpectedly found that multiple short hot water vapor and dry cycles can achieve significantly lower resistance than a single long treatment, and in shorter time. One effect of multiple hot water vapor/dry treatments is to cause repeated swelling and shrinking that “work” the silver particles into a more highly connected form. X-ray fluorescence measurements show a small increase in silver crystallite size after multiple hot water vapor treatments: 18 nm before; and 22 nm after.

Additional experiments were conducted with the electrically conductive film showing that the weight of the dry film increases significantly in the first 5 seconds of hot water vapor treatment. After 15 seconds the weight of the sample had increased almost to its saturation point. It was found that 15 to 20 seconds of hot water vapor treatment was an effective amount of treatment time.

Additional experiments were conducted where, rather than holding the treated sample over a hot plate, it was placed in a 100° C. convection oven. Measuring the weight of wet hot water vapor treated samples at various dryer times also showed that 15 to 20 seconds of dryer time was enough to substantially return the sample to its dry weight. It was found 15 to 20 seconds of dryer time at 80° C. to 100° C. to be effective.

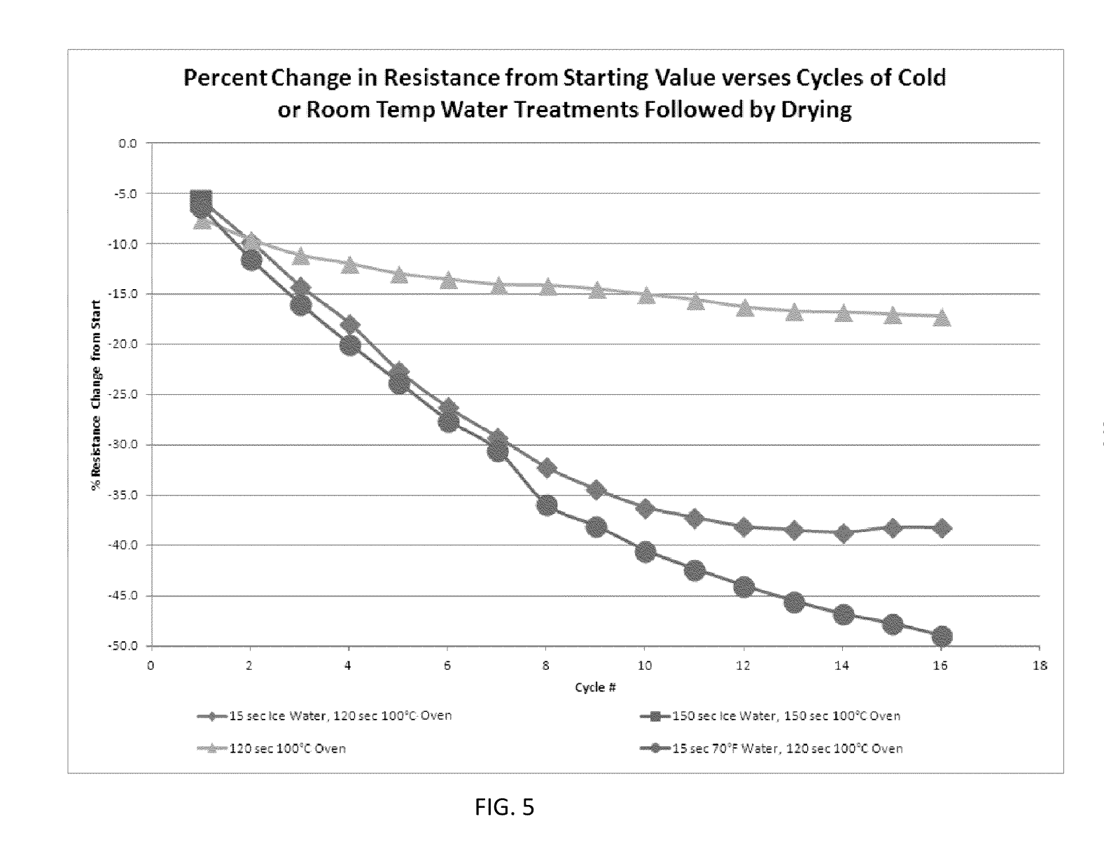

In another set of experiments, the unexpected effect of multiple treatments was observed by replacing a hot water vapor treatment with a cold or room temperature water bath treatment, followed by drying. In these experiments, the starting film samples were similar to those of Examples 1-3, except that the film process included an immersion in a BVSM hardener bath to improve the physical robustness of the films. It was found that a single immersion into ice water followed by drying in a 100° C. oven for 120 seconds, produced only a very small reduction in resistance (roughly 6%), and the magnitude of the improvement was about the same whether the immersion was 15 sec or 150 sec. If the process was repeated multiple times, the resistance continues to improve. FIG. 5 shows the effect of multiple cold (ice water) or room temperature (70° F.) water bath cycles. Also shown is the effect of heating in a 100° C. oven for 120 seconds multiple times. Heating in this fashion only improves the resistivity by 17% or less. A 30% reduction in resistivity can be achieved with 7 cycles of either the cold or room temperature water bath (with intervening drying). Almost 50% improvement can be reached with 16 cycles using simple room temperature water. Although not as effective as hot water vapor, an advantage of the multiple water bath/dry cycles is the simplicity of the system and the ease of handling cold or room temperature water versus hot water vapor.

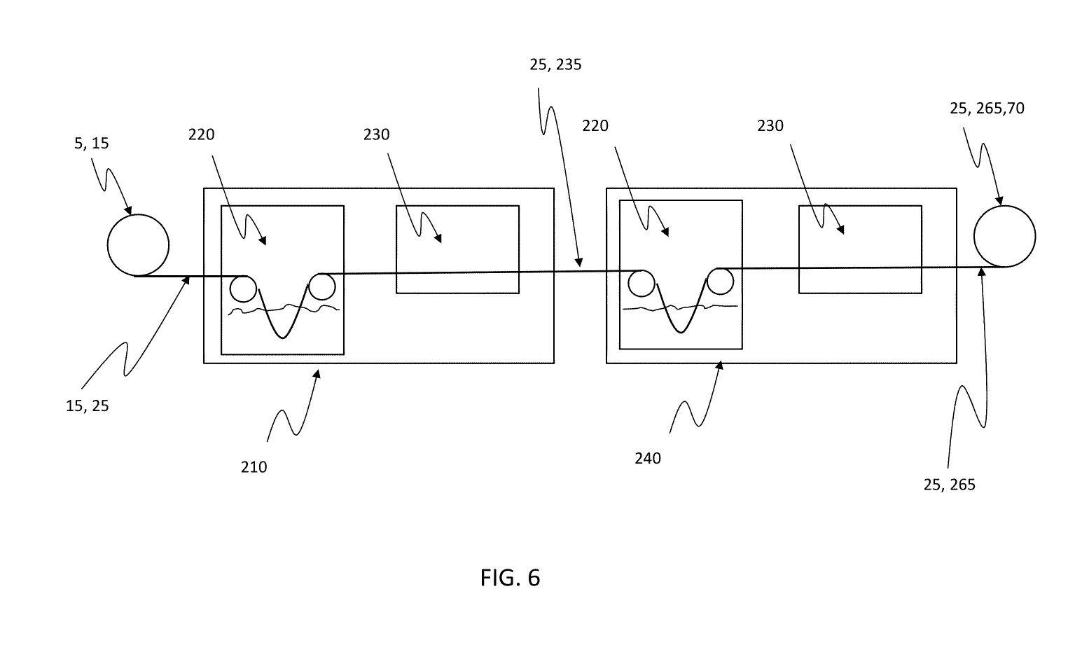

FIG. 6 illustrates an embodiment using multiple water bath/dry cycles. FIG. 6 shows a first set of stations 210, and a second set of stations 240. Each set of stations contains a water bath treatment station 220 followed by a drying station 230. A roll of exposed and processed silver-containing conductive film 15 is loaded into the supply spool 5. The web 25 of exposed and processed silver-containing conductive film 15 is input to the first set of stations 210 where it passes through the water bath treatment station 220, followed by the drying station 230 and exits as the web 25 of treated conductive film 235. The web 25 of treated conductive film 235 then enters the second set of stations 240 where it passes through the water bath treatment station 220, followed by the drying station 230 and exists as the web 25 of additionally treated conductive film 265. Web 25 of additionally treated conductive film 265 is then wound onto a take-up spool 70 and is then ready for use.

It will be recognized that first set of stations 210 and second set of stations 240 can be one physical unit and the web 25 of material can be passed through the first set of stations 210 multiple times.

It will be recognized that additional set of stations can be placed in line and the web can be processed more than two times. It will be recognized that the duration and temperature of the water bath treatment station, the length and temperature of the drying station, and the speed of the web can be adjusted to optimize the treatments. The adjustments can be dependent upon the treatment cycle number and the conductive film type.

It will be recognized that the invention can be applied using cut sheets of silver-containing conductive film and moving the film through the first and second set of stations on a belt or a conveyor. It will be recognized that the invention can be applied using cut sheets of silver-containing conductive film and moving the film through a single first set of stations multiple times.

The invention has been described in detail with particular reference to certain preferred embodiments thereof, but it will be understood that variations and modifications can be effected within the spirit and scope of the invention.

### PARTS LIST

5 supply spool
10 first set of stations
15 silver-containing conductive film
20 hot water vapor station
25 web
30 drying station
35 treated conductive film
40 second set of stations
65 additionally treated conductive film
70 take-up spool
110 support
120 photographic emulsion layer
125 hydrophilic binder
126a-f hydrophilic binder
127a-f printed areas
130a-f conductive traces
131a-f conductive metal nanoparticles
210 first set of stations
220 water bath treatment station
230 drying station
235 treated conductive film
240 second set of stations
265 treated conductive film

1. A method of enhancing the conductivity of silver in a silver-containing film formed on a substrate, comprising:
(a) providing the silver-containing film, including silver particles and a hydrophilic binder;
(b) exposing the silver-containing film to hot water vapor so that the binder absorbs water;
(c) drying the silver-containing film to remove water in the binder; and
(d) repeating elements (b) and (c) at least one time, so as to enhance the conductivity of the silver.

2. The method of claim 1, wherein the hydrophilic binder includes a gelatin-based material.

3. The method of claim 1 wherein element (b) includes providing the hot water vapor is in a temperature range from 80° C. to 110° C.

4. The method of claim 3 wherein the temperature of the hot water vapor is in a range from 90° C. to 100° C.

5. The method of claim 1, wherein element (b) includes exposing the silver-containing film to hot water vapor in a time range from 1 seconds to 60 seconds.

6. The method of claim 5, wherein the time range from 5 seconds to 30 seconds.

7. The method of claim 3 wherein element (b) includes exposing the silver-containing film to hot water vapor in a time range from 1 seconds to 60 seconds.

8. The method of claim 7, wherein the time range from 5 seconds to 30 seconds.

9. The method of claim 1 wherein element (c) includes drying at a temperature in a range from 40° C. to 140° C.

10. The method of claim 9 wherein the temperature is in a range from 60° C. to 100° C.

11. The method of claim 1, wherein the silver particles are provided by developing a photosensitive silver-containing salt.

12. The method of claim 1 wherein element (d) includes repeating elements (b) and (c) at least two times.

13. The method of claim 12 wherein elements (b) and (c) are repeated at least four times.

14. A method of enhancing the conductivity of silver in a silver-containing film formed on a substrate, comprising:
(a) providing the silver-containing film, including silver particles and a hydrophilic binder;
(b) swelling the hydrophilic binder;
(c) shrinking the hydrophilic binder; and
(d) repeating elements (b) and (c) at least one time to work the silver particles thereby enhancing the conductivity of the silver.

15. The method of claim 14 wherein element (d) includes repeating elements (b) and (c) at least two times.

16. The method of claim 15 wherein elements (b) and (c) are repeated at least four times.

17. A method of enhancing the conductivity of silver in a silver-containing film formed on a substrate, comprising:
(a) providing the silver-containing film, including silver particles and a binder on the substrate;
(b) providing a first set of stations including a first hot water vapor station for exposing the silver-containing film to hot water vapor so that the binder absorbs water, and a first drying station spaced from the hot water vapor station to dry the silver-containing film to remove water in the binder; and
(c) advancing the silver-containing film on the substrate through the first set of stations in sequence through the first hot water vapor station and the first drying station.

18. The method of claim 17, further including providing a second set of stations spaced from the first set of stations, including a second hot water vapor station for exposing the silver-containing film to hot water vapor so that the binder absorbs water, and a second drying station spaced from the hot water vapor station to dry the silver-containing film to substantially remove the water in the binder; and
after element (c), advancing the silver-containing film on the substrate through the second set of stations in sequence through the second hot water vapor station and the second drying station.

19. The method of claim 1 wherein element (b) includes providing the hot water vapor is in a temperature range from 80° C. to 110° C.

20. The method of claim 19 wherein element (b) includes exposing the silver-containing film to hot water vapor in a time range from 1 seconds to 60 seconds.

21. The method of claim 20, wherein the time range from 5 seconds to 30 seconds.
